(19) United States
(12) Patent Application Publication
(10) Pub. No.: US 2010/0242004 A1
(43) Pub. Date: Sep. 23, 2010

(54) METHOD OF SEMICONDUCTOR CIRCUIT DEVICE

(75) Inventor: Hiroshi ITO, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/726,010

(22) Filed: Mar. 17, 2010

(30) Foreign Application Priority Data
Mar. 18, 2009 (JP) 2009-066856

(51) Int. Cl. G06F 17/50

(52) U.S. Cl. 716/5; 716/10; 716/12

(57) ABSTRACT

A designing method of a semiconductor circuit device includes the following steps. The steps are: generating a circuit diagram data indicating a semiconductor circuit device which includes power source separation regions, each provided with cells which include retention flip-flops; generating a net list between the power source separation region and the node based on the circuit diagram data; when an output of a first power source separation region is connected an input of a second power source separation region, and a first power source for the first power source separation region is turned off, searching a first searched cell indicating a retention flip-flop closest to the output of the first power source separation region from the first power source separation region based on the net list; searching a second searched cell between the first searched cell and the output of the first power source separation region from the first power source separation region based on the net list; replacing the first power source for an output of the first searched cell by a second power source which supplies the same voltage as the first power source and is in an on-state; and replacing the first power source for the second searched cell by the second power source.

### INCORPORATION BY REFERENCE

This application is based upon and claims the benefit of priority from Japanese patent application No. 2009-066856 filed on Mar. 10, 2009, the disclosure of which is incorporated herein in its entirety by reference.

### BACKGROUND OF THE INVENTION

1. Field of the Invention

The present invention relates to a designing method of a semiconductor circuit device.

2. Description of Related Art

In recent years, the number of transistors to be installed in one chip is dramatically increased due to improvement of a semiconductor micro fabrication technique. As a semiconductor is made finer, it is necessary to suppress a power supply voltage to be applied to the semiconductor to below. Also, as electric power consumption is increased due to increase of the number of the transistors to be installed, the power supply voltage has to be lowered in order to suppress the increase of the electric power consumption.

However, if the power supply voltage is lowered, an ON current of the transistor is reduced, thereby leading to a large signal delay. In order to meet a demand for achieving a high speed operation, it is necessary to lower a threshold voltage of the transistor. However, if a threshold voltage of the transistor is lowered, there arises a problem that a leak current becomes large.

In order to reduce the leak current, the most effective way is to turn off the power supply. Accordingly, the reduction of the leak current is advanced by adopting a designing method such that a plurality of regions to be supplied with electric power are prepared so that the power supply for regions in a standby state is turned off among the plurality of regions. Even in the case where a plurality of regions are used while the power supply for the unnecessary regions is turned off, it is desired to obtain an optimum design such that electric power consumption is reduced in the regions in the power-on state.

As a related technique, Japanese Patent Publication JP2004-335843A (corresponding U.S. Pat. No. 7,103,866 (B2)) discloses a designing method of a semiconductor circuit device. The technique disclosed in JP2004-335643A will be briefly explained here with reference to attached drawings.

FIG. 1 is a chip image diagram showing a schematic configuration of a related semiconductor circuit device 100. The semiconductor circuit device 100 includes a plurality of regions that are supplied with voltages by different power supply systems. Among the plurality of regions, a first region operating by a first power supply system is referred to as a region 101, a second region operating by a second power supply system is referred to as a region 102.

A power supply voltage VDD1 as a first power supply voltage is supplied to the region 101 and a power supply voltage VDD2 as a second power supply voltage is supplied to the region 102. These two voltages are separately controlled. The semiconductor circuit device 100 further includes boundary circuits 131, 132, 133 and 134 which are located between the region 101 and the region 102.

FIG. 2A shows a circuit configuration of an indeterminate propagation preventing circuit 200 exemplified as the boundary circuits 131, 132, 133 and 134. By providing the indeterminate propagation preventing circuit 200 between the region 101 and the region 102, an indeterminate signal can be prevented from propagating from the region in a power-off state (hereinafter referred to as “OFF state”) to the region in a power-on state (hereinafter referred to as “ON state”).

As shown in FIG. 2A, the region 101 in the OFF state is assumed as an OFF region (power supply voltage VDD1 is not supplied to the region 101) and the region 102 in the ON state is assumed as an ON region (power supply voltage VDD2 is supplied to the region 102). The indeterminate propagation preventing circuit 200 includes an input terminal 201, an inverter 202, a NAND gate 203, an enable terminal 204 and an output terminal 205. A signal from the region 101 is supplied to the input terminal 201. The inverter 202 is operated by the power supply voltage VDD1 and receives the signal supplied to the input terminal 201. An enable signal from the region 102 in the ON state is supplied to the enable terminal 209. The NAND gate 203 is operated by the power supply voltage VDD2, and receives the output signal of the inverter 202 and the enable signal supplied to the enable terminal 209. An output of the NAND gate 203 is connected to the output terminal 205. An output signal of the output terminal 205 is supplied to the region 102 in the ON state.

FIG. 2B is a truth table showing a relationship among the input signal “input” applied to the input terminal 201, the enable signal “enable” applied to the enable terminal 204 and the output signal “output” outputted of the output terminal 205. Herein, “X”, “1” and “0” shown in FIG. 2B denote signal levels and the signal level “X” denotes an indeterminate level. The signal level “0” denotes an output voltage to be a “Low” level, and, the signal level “1” denotes an output voltage to be a “High” level. When the region 101 is in the OFF state, an indeterminate signal is supplied to the input terminal 201.

That is, when the region 101 is in the OFF state, the output signal from the region 101 to the region 102 is not determined whether the signal level thereof is High or Low. Therefore, an intermediate potential signal is applied to the region 102. This generates a penetration current into the region 102. In order to suppress this penetration current, the enable signal to be inputted to the NAND gate 203 is controlled to be “0”, i.e., “Low” when the region 101 is in the OFF state. By setting the enable signal to be “0”, the output signal of the output terminal 205 can be set to be “1”, i.e., the output voltage can be determined to be “High” to be retained. Thus, it is possible to suppress a penetration current in the power-on region due to an indeterminate signal supplied from the power-off region.

When the region 101 is in the ON state, the indeterminate propagation preventing circuit 200 is so controlled as to be supplied with an enable signal of “1”. Thus, the output signal supplied from the output terminal 205 to the region 102 is determined to be “0” when the input signal supplied from the region 101 to the input terminal 201 is “0”, and the output signal is determined to be “1” when the input signal is “1”. In addition, when the input signal is not determined and the enable signal is “1” or indeterminate, the output signal is indeterminate.

As another related technique, Japanese Patent Publication JP2006-344640A (corresponding to U.S. Pat. No. 7,610,572 (B2)) discloses a semiconductor integrated circuit device. The technique disclosed in JP2006-344640A will be briefly explained here. This semiconductor integrated circuit device includes: a first power source; and first to M-th functional blocks which are operated by second to (M+1)-th power sources different from the first power source and other power sources used for the other functional blocks. The first to M-th functional blocks are integrated on one chip. The second to (M+1)-th power sources are supplied with electric power independently of each other. The first to M-th functional blocks are controllable in power shutdown thereof independently of each other, and the priorities of the power shutdown are given thereto, respectively. The relation between the priorities is established based on relationships of signal line connections wherein the signal line connections are structured in hierarchy to be embodied. Among lower hierarchical J-th and K-th functional blocks and an L-th functional block located in a higher hierarchy than the J-th and K-th functional blocks in the first to M-th functional blocks, when a signal transmission is executed from the J-th functional block to the K-th functional block, the signal is propagated via a signal relay buffer circuit provided inside the L-th functional block. When a signal is transferred from the J-th functional block to the L-th functional block, the signal is transferred via the indeterminate propagation preventing circuit.

We have now discovered the following facts.

In the related techniques, the indeterminate propagation preventing circuit and the circuit for generating an enable signal are both required. Therefore, these circuits are provided between the regions, which results in increase of a chip area. Accordingly, it is desired to suppress an increase of the chip area and to prevent an indeterminate signal from propagating from a region in a power-off state to a region in a power-on state.

### SUMMARY

The present invention seeks to solve one or more of the above problems, or to improve upon those problems at least in part.

In one embodiment, a designing method of a semiconductor circuit device includes: generating a circuit diagram data indicating a semiconductor circuit device which includes a plurality of power source separation regions, each of the plurality of power source separation regions being provided with a plurality of cells which includes a plurality of retention flip-flops; generating a net list indicating wiring lines between the plurality of power source separation regions and nodes connected thereof, based on the circuit diagram data; when an output of a first power source separation region of the plurality of power source separation regions is connected to an input of a second power source separation region of the plurality of power source separation regions, and a first power source supplied to the first power source separation region is turned off, searching a first searched cell indicating a retention flip-flop closest to the output of the first power source separation region from the plurality of cells of the first power source separation region, based on the net list; searching a second searched cell between the first searched cell and the output of the first power source separation region from the plurality of cells of the first power source separation region, based on the net list; replacing a power source supplied to an output of the first searched cell from the first power source to a second power source which supplies the same voltage as that of the first power source and is in an on-state all the time; and replacing a power source supplied to the second searched cell from the first power source to the second power source.

In another embodiment, a computer-readable medium including a computer program comprising code operable to control a computer for a designing method of a semiconductor circuit device, the code includes: generating a circuit diagram data indicating a semiconductor circuit device which includes a plurality of power source separation regions, each of the plurality of power source separation regions being provided with a plurality of cells which includes a plurality of retention flip-flops; generating a net list indicating wiring lines between the plurality of power source separation regions and nodes connected thereof, based on the circuit diagram data; when an output of a first power source separation region of the plurality of power source separation regions is connected to an input of a second power source separation region of the plurality of power source separation regions, and a first power source supplied to the first power source separation region is turned off, searching a first searched cell indicating a retention flip-flop closest to the output of the first power source separation region from the plurality of cells of the first power source separation region, based on the net list; searching a second searched cell between the first searched cell and the output of the first power source separation region from the plurality of cells of the first power source separation region, based on the net list; replacing a power source supplied to an output of the first searched cell from the first power source to a second power source which supplies the same voltage as that of the first power source and is in an on-state all the time; and replacing a power source supplied to the second searched cell from the first power source to the second power source.

In another embodiment, a designing system of a semiconductor circuit device includes: a circuit diagram data generating portion configured to generate a circuit diagram data indicating a semiconductor circuit device which includes a plurality of power source separation regions, each of the plurality of power source separation regions being provided with a plurality of cells which includes a plurality of retention flip-flops; a net list generating portion configured to generate a net list indicating wiring lines between the plurality of power source separation regions and nodes connected thereof, based on the circuit diagram data; and an indeterminate propagation preventing portion. When an output of a first power source separation region of the plurality of power source separation regions is connected to an input of a second power source separation region of the plurality of power source separation regions, and a first power source supplied to the first power source separation region is turned off, the indeterminate propagation preventing portion; searches a first searched cell indicating a retention flip-flop closest to the output of the first power source separation region from the plurality of cells of the first power source separation region, based on the net list; searches a second searched cell between the first searched cell and the output of the first power source separation region from the plurality of cells of the first power source separation region, based on the net list; replaces a power source supplied to an output of the first searched cell from the first power source to a second power source which supplies the same voltage as that of the first power source and is in an on-state all the time, and replaces a power source supplied to the second searched cell from the first power source to the second power source.

In another embodiment, a semiconductor circuit device designed by a designing method of a semiconductor circuit device, wherein the designing method includes: generating a circuit diagram data indicating a semiconductor circuit device which includes a plurality of power source separation regions, each of the plurality of power source separation regions being provided with a plurality of cells which includes a plurality of retention flip-flops; generating a net list indicating wiring lines between the plurality of power source separation regions and nodes connected thereof, based on the circuit diagram data; when an output of a first power source separation region of the plurality of power source separation regions is connected to an input of a second power source separation region of the plurality of power source separation regions, and a first power source supplied to the first power source separation region is turned off, searching a first searched cell indicating a retention flip-flop closest to the output of the first power source separation region from the plurality of cells of the first power source separation region, based on the net list; searching a second searched cell between the first searched cell and the output of the first power source separation region from the plurality of cells of the first power source separation region, based on the net list; replacing a power source supplied to an output of the first searched cell from the first power source to a second power source which supplies the same voltage as that of the first power source and is in an on-state all the time; and replacing a power source supplied to the second searched cell from the first power source to the second power source.

According to the designing method of the semiconductor integrated circuit device of the present invention, it is possible to prevent an indeterminate signal from propagating from a region in a power-off state (e.g. the first power source separation region) to a region in a power-on state (e.g. the second power source separation region). In addition, since there is no need to provide an indeterminate propagation preventing circuit and an enable signal generation circuit between the regions, it is possible to suppress the increase of the chip area.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a chip image diagram showing a schematic configuration of a related semiconductor circuit device 100;

FIG. 2A shows a circuit configuration of an indeterminate propagation preventing circuit 200 as one of the boundary circuits 131, 132, 133 and 134 shown in FIG. 1;

FIG. 2B shows a truth table of the indeterminate propagation preventing circuit 200;

FIG. 3 shows a configuration of a designing system adopting a designing method of a semiconductor circuit device according to first and second embodiments of the present invention;

FIG. 4 is a flow chart showing a designing method of a semiconductor integrated circuit device according to the first and second embodiments of the present invention and showing an operation of a computer 1;

FIG. 5 shows circuit diagram data 71 in the designing method of the semiconductor integrated circuit device according to the first and second embodiments of the present invention;

FIG. 6 shows a net list 72 in the designing method of the semiconductor integrated circuit device according to the first and second embodiments of the present invention;

FIG. 7 is a flowchart showing an indeterminate signal propagation preventing process of the designing method of the semiconductor integrated circuit device according to the first embodiment of the present invention;

FIG. 8A is a circuit diagram showing a configuration of cells 23, 25 and 27 (retention flip-flops) in the designing method of the semiconductor integrated circuit device according to the first and second embodiments of the present invention;

FIG. 8B is a circuit diagram showing a configuration of output-determined cells 33 and 37 (retention flip-flops) in a power-off state in the designing method of the semiconductor integrated circuit device according to the first and second embodiments of the present invention;

FIG. 9A is a circuit diagram showing a configuration of cells 24 and 26 (buffers) in the designing method of the semiconductor integrated circuit device according to the first and second embodiments of the present invention;

FIG. 9B is a circuit diagram showing a configuration of a normally power-on cell 34 (buffer) in the designing method of the semiconductor integrated circuit device according to the first and second embodiments of the present invention;

FIG. 10A shows a retention flip-flop replacement list 73 in the designing method of the semiconductor integrated circuit device according to the first and second embodiments of the present invention;

FIG. 10B is a normally power-on cell replacement list 74 in the designing method of the semiconductor integrated circuit device according to the first and second embodiments of the present invention;

FIG. 11 show circuit diagram data 75 adopting an indeterminate propagation preventing process in the designing method of the semiconductor integrated circuit device according to the first and second embodiments of the present invention; and

FIG. 12 is a flow chart showing an indeterminate signal propagation preventing process in the designing method of the semiconductor integrated circuit device according to the second embodiment of the present invention.

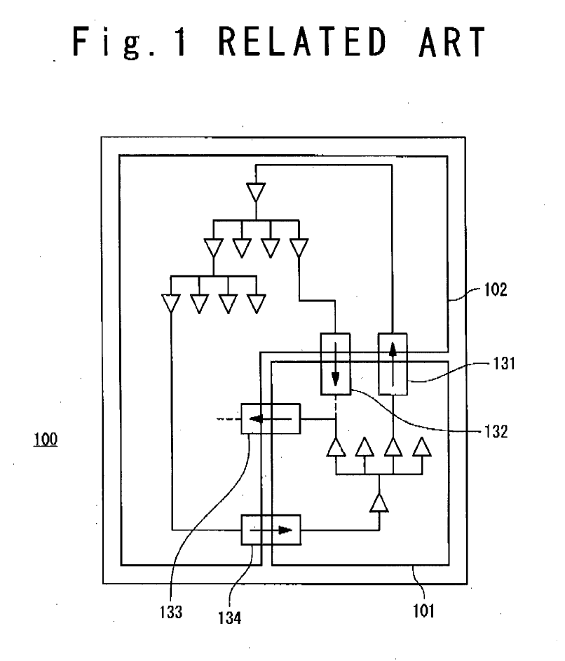

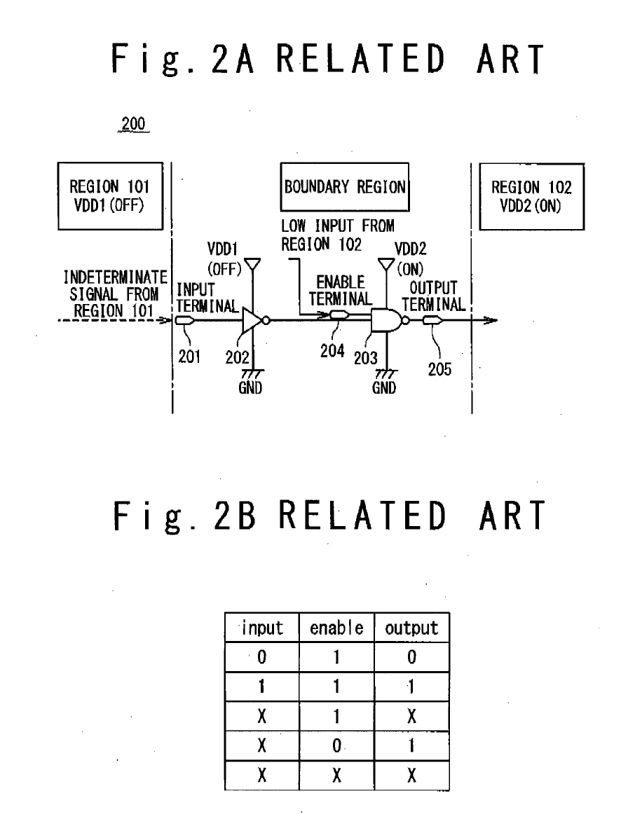

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

The following describes in detail a designing method of a semiconductor circuit device according to embodiments of the present invention referring to the accompanying drawings.

### First Embodiment

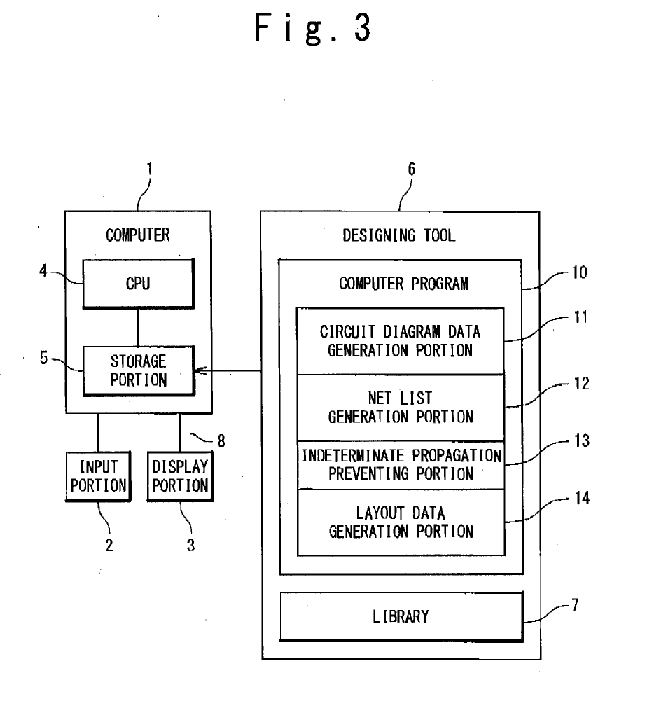

FIG. 3 shows a configuration of a designing system adopting a designing method of a semiconductor integrated circuit device according to a first embodiment of the present invention. The designing system includes: a computer 1; an input portion 2 operated by a user; and a display portion 3 for displaying layout data 8. The input portion 2 and the display portion 3 are connected to the computer 1.

The computer 1 includes: a storage portion 5 for storing a computer program and data; and a CPU (Central Processing Unit) 4 acting as an execution port ion executing the computer program.

The designing system further includes a designing tool 6 which is software. The designing tool 6 is installed in the storage portion 5. The designing tool 6 may be originally stored in a computer readable recording medium (not shown) or a server (not shown) connected with the computer 1 through a network not shown). The designing tool 6 includes a computer program 10 and a library (file) 7.

The computer program 10 includes a circuit diagram data generation portion 11, a net list generation portion 12, an indeterminate propagation preventing portion 13 and a layout data generation portion 14.

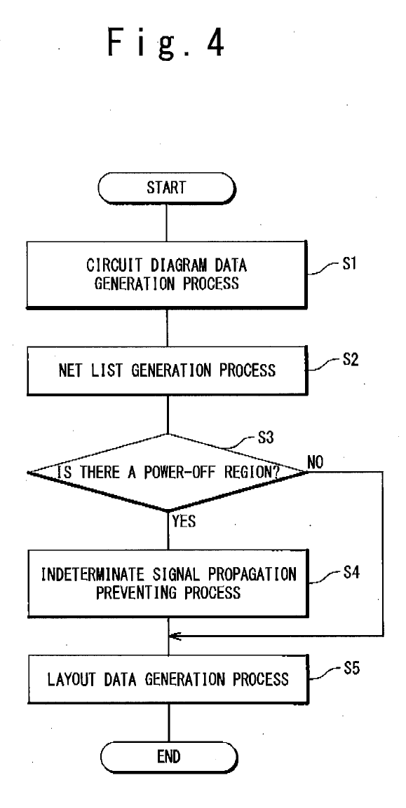

FIG. 4 is a flow chart showing an operation of the computer 1 for explaining the designing method of the semiconductor integrated circuit device according to the first embodiment of the present invention.

First, a user executes a designing tool calling instruction using the input portion 2 to thereby start up the designing tool 6 in response to the designing tool calling instruction.

A designer previously builds or prepares the library 7 using the input portion 2 before designing the semiconductor integrated circuit. In this case, the circuit diagram data generation portion 11 generates data indicative of a cell in response to the operation of the input portion 2 by the designer. Next, the designer gives a storage instruction to the computer 1 using the input portion 2. The circuit diagram data generation portion 11 stores the data indicative of the cell in the library 7 according to the storage instruction.

Next, the designer designs the semiconductor integrated circuit using the input portion 2 (Step S1: circuit diagram data generation process). In this case, the circuit diagram data generation portion 11 displays a circuit diagram data generation screen on the display portion 3 based on the operation of the input portion 2 by the designer. The user depicts a desired circuit diagram on the circuit diagram data generation screen using the input portion 2. The circuit diagram data generation portion 11 generates the circuit diagram as the circuit diagram data according to the operation of the input portion 2 by the user.

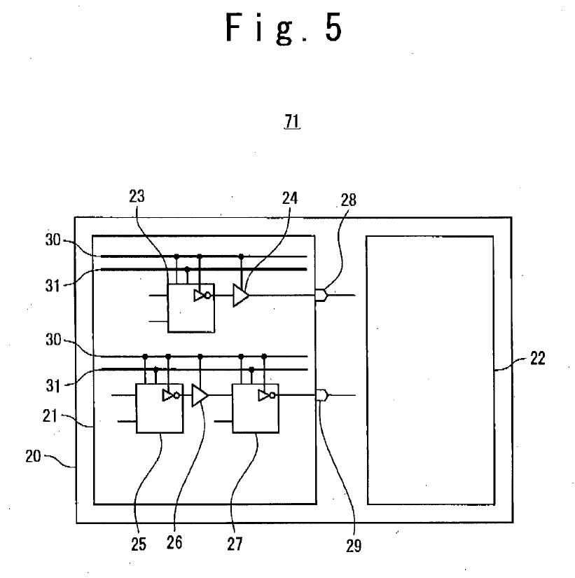

FIG. 5 shows circuit diagram data 71 as mentioned above. The circuit diagram data 71 represents a semiconductor circuit device 20 including a plurality of power source separation regions 21, 22, . . . . The plurality of power source separation regions 21, 22, . . . is individually supplied with different power sources. Each of the plurality of power source separation regions 21, 22, . . . is provided with a plurality of cells. Here, it is presumed that the output of the first power source separation region 21 among the plurality of power source separation regions 21, 22, . . . is connected to the input of the second power source separation region 22. In this case, the first power source separation region 21 is provided with a plurality of cells 23 to 27 as the plurality of cells mentioned above. The output of the cell 23 is connected to the input of the cell 24. The output of the cell 24 is connected to the input of the second power source separation region 22 via an output terminal 28. The output of the cell 25 is connected to the input of the cell 26. The output of the cell 26 is connected to the input of the cell 27. The output of the cell 27 is connected to the input of the second power source separation region 22 via an output terminal 29. The cells 23, 25 and 27 represent retention flip-flops. The cells 24 and 26 represent buffers.

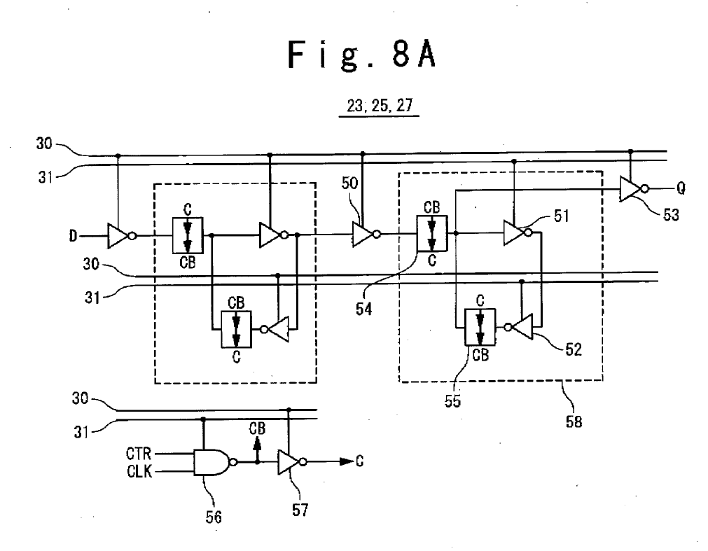

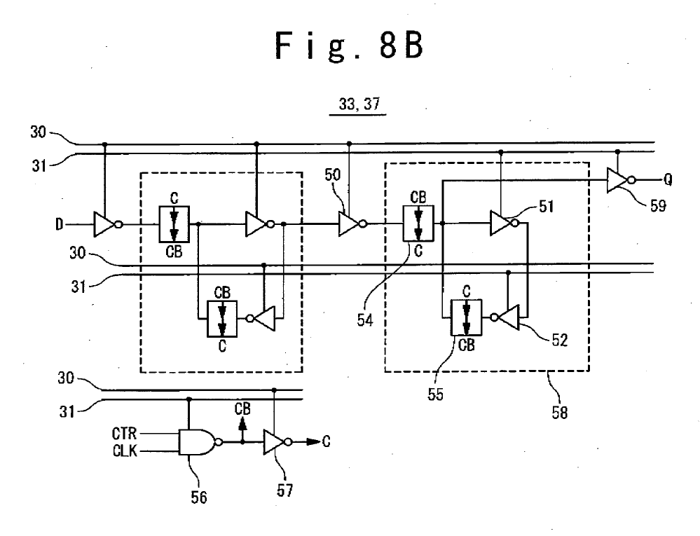

As shown in FIG. 8A, each of the cells 23, 25 and 27 (i.e., retention flip-flops) includes: an input circuit 50 inputting data; a holding circuit 58 for holding the data; and an output circuit 53 outputting data based on an internal clock signal C and its inverse signal CB. The input circuit 50 is an inverter. The holding circuit 58 includes inverters 51 and 52 and transfer gates 54 and 55. The output circuit 53 is an inverter. The output of the inverter 51 is connected to the input of, the inverter 52. The transfer gate 54 is connected between the output of the input circuit 50 and the input of the inverter 51. The transfer gate 55 is connected between the output of the inverter 52 and the input of the inverter 51. The input of the inverter 53 is connected to the input of the inverter 51. The output of the inverter 53 is connected to the buffer or the output terminal.

Alternatively, there may be provided a plurality of circuits each including the input circuit 50 and the holding circuit 5B, and the plurality of circuits may be connected in series. In this case, the input of the inverter 53 is connected to the input of the inverter 51 provided in the circuit located at the backend of the plurality of circuits.

The input circuit 50 and the output circuit 53 are connected to the first power source 30. The first power source 30 is turned en or off based on the specifications. The inverters 51 and 52 are connected to the second power source 31. The second power source 31 supplies the same voltage as that of the first power source 30 and is in the ON state all the time.

The internal clock signal C and its inverse signal CB are obtained by a NAND circuit 56 and an inverter 57. The output of the NAND circuit 56 is connected to the input of the inverter 57. The NAND circuit 56 is connected to the second power source 31 and the inverter 57 is connected to the first power source 30. A control signal CTR and a clock signal CLK are supplied to the input of the NAND circuit 56 and an output signal of the inverter 57 is used as the internal clock signal C mentioned above. The input signal applied to the inverter 57 is also used as the inverse signal CB mentioned above. The transfer gates 54 and 55 are turned on or off based on the internal clock signal C and its inverse signal CB.

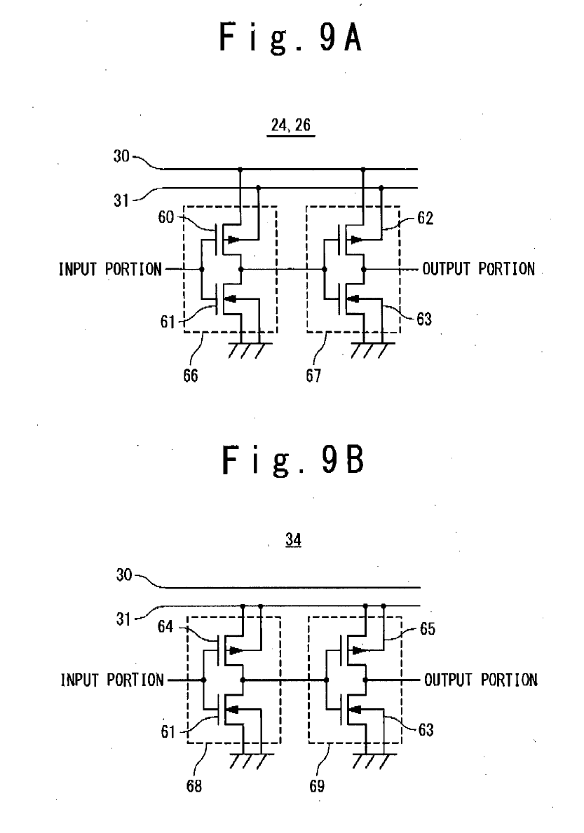

As shown in FIG. 9A, each of the cells 24 and 26 (buffer) includes a first inverter 66 and a second inverter 67 connected in series as a plurality of circuits. The first inverter 66 is provided with a P-channel transistor 60 and an N-channel transistor 61. The gates of the P-channel transistor 60 and N-channel transistor 61 are used as the input of the first inverter 66. That is, the input of the first inverter 66 is used as an input terminal of the buffer. A drain of the P-channel transistor 60 and a drain of the N-channel transistor 61 are used as the output of the first inverter 66. The second inverter 67 is provided with a P-channel transistor 62 and an N-channel transistor 63. The gates of the P-channel transistor 62 and the N-channel transistor 63 are used as the input of the second inverter 67. The input of the second inverter 67 is connected to the output of the first inverter. A drain of the P-channel transistor 62 and a drain of the N-channel transistor 63 are used as the output of the second inverter. That is, the output of the second inverter 67 is used as an output terminal of the buffer.

The sources of the N-channel transistors 61 and 63 are grounded. The sources of the P-channel transistors 60 and 62 are connected to the first power source 30. The back-gates of the P-channel transistors 60 and 62 are connected to the second power source 31.

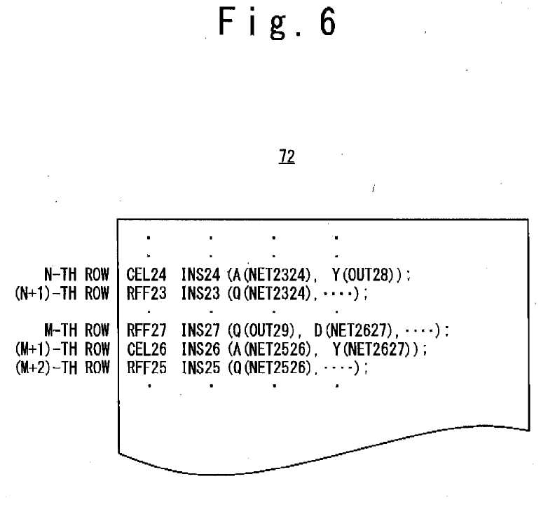

Next, the net list generation portion 12 generates a net list 72 as shown in FIG. 6 based on the circuit diagram data 71 (Step S2: net list generation process). The net list 72 represents the plurality of power source separation regions 21, 22, . . . and wiring lines connecting between the nodes and the plurality of power source separation regions 21, 22, . . . , respectively.

In the net list 72 as shown in FIG. 6, it is presumed that the names of the cells 23 to 27 are RFF23, CEL24, RFF25, CEL26 and RFF27, respectively. It is presumed that the names of the output terminals 28 and 29 are OUT28 and OUT29, respectively.

The cell name CEL24 of the cell 24 and an instance name INS24 of the cell 24 are described in the n-th row of the net list 72. The instance name INS24 includes net information A (NET2324) showing the connection between the input of the cell 24 and the output of the cell 23 and net information Y (OUT28) showing the connection between the output of the cell 24 and the output terminal 28.

The cell name RFF23 of the cell 23 and an instance name INS23 of the cell 23 are described in a (n+1)-th row of the net list 72. The instance name INS23 includes net information Q (NET2324) showing the connection between the input of the cell 24 and the output of the cell 23.

The cell name RFF27 of the cell 27 and an instance name INS27 of the cell 27 are described in an m-th row of the net list 72. The instance name INS27 includes net information Q (OUT29) showing the connection between the output of the cell 27 and the output terminal 29 and net information D (NET2627) showing the connection between the input of the cell 27 and the output of the cell 26.

The cell name CEL26 of the cell 26 and an instance name INS26 of the cell 26 are described in a (m+1)-th row of, the net list 72. The instance name INS26 includes net information A (NET2526) showing the connection between the output of the cell 25 and the input of the cell 26 and net information Y (NET2627) showing the connection between the output of the cell 26 and the input of the cell 27.

The cell name RFF25 of the cell 25 and an instance name INS25 of the cell 25 are described in a (m+2)-th row of the net list 72. The instance name INS25 includes net information Q (NET2526) showing the connection between the output of the cell 25 and the input of the cell 26.

Here, it is presumed that the first power source 30 to be supplied to each of the plurality of the power source separation regions 21, 22, is not turned off based on the specifications (No in Step S3). In this case, the layout data generation portion 14 generates the layout data 8 showing a layout formation based on the circuit diagram data 71 and the net list 72 and displays, the layout data 8 on the display portion 3 (Step S5).

On the other hand, it is presumed that the first power source 30 to be supplied to the first power source separation region 21 among the plurality of the power source separation regions 21, 22, . . . is turned off based on the specifications (Yes in Step S3). In this case, it should be prevented that an indeterminate signal is propagated from the first power source separation region 21 to the second power source separation region 22.

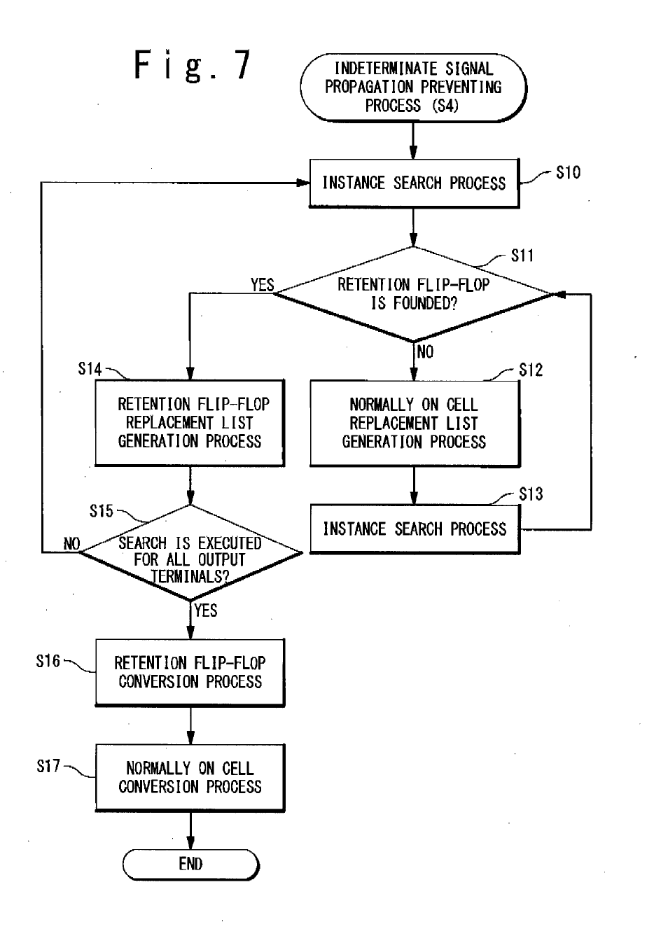

FIG. 7 is a flow chart showing an indeterminate signal propagation preventing process (Step S4) of the semiconductor integrated circuit device according to the first embodiment of the present invention.

The indeterminate propagation preventing portion 13 searches a cell, as a searched cell, closest to the output (i.e., output terminal 28) of the first power source separation region 21, among the plurality of cells 23 to 27 of the first power source separation region 21 based on the net list 72. In this process, the search cell is searched using an instance name (Step S10: instance search process).

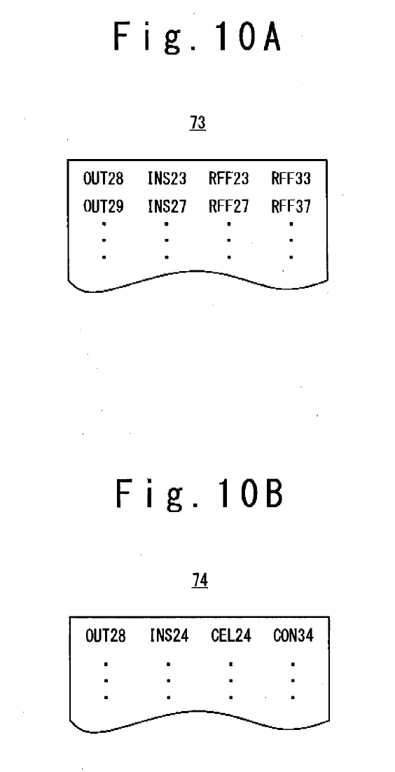

The searched cell closest to the output terminal 28 is the cell 24 which represents a buffer (No in Step S11). In this case, the indeterminate propagation preventing portion 13 generates a normally ON cell replacement list 74 as shown in FIG. 10B. The indeterminate propagation preventing portion 13 correlates the instance name INS24 and the cell name CEL24 of the cell 24 with a cell name CON34 which is a name of a normally ON cell 34 (shown in FIG. 9B) representing that the second power source 31 is the power source supplying power to the cell 24 (buffer), whereby describing the correlation in the normally ON cell replacement list 74 (Step S12: normally ON cell replacement list generation process).

The indeterminate propagation preventing portion 13 searches a cell closest to the cell 24 among the plurality of cells 23 to 27 of the first power source separation region 21 based on the net list 72. In this process, the searched cell is searched using the instance name (Step S13: instance search process).

The searched cell closest to the cell 24 is the cell 23 which represents a retention flip-flop (Yes in Step S11). In this case, the indeterminate propagation preventing portion 13 generates a retention flip-flop replacement list 73 as shown in FIG. 10A. The indeterminate propagation preventing portion 13 correlates the instance name INS23 and the cell name RFF23 of the cell 23 with a cell name RFF33 which is a name of a power-off state output determinate 15, cell 33 (shown in FIG. 8B) representing that the second power source 31 is the power source supplying power to the output of the cell 23 (retention flip-flop), whereby describing the correlation in the retention flip-flop replacement list 73 (Step S14: retention flip-flop replacement list generation process).

The indeterminate propagation preventing portion 13 searches a cell, as a searched cell, closest to the output (i.e., output terminal 29) of the first power source separation region 21, among the plurality of cells 23 to 27 of the first power source separation region 21 based on the net list 72. In this process, the searched cell is searched using an instance name (No in Step S15 to Step S10).

The searched cell closest to the output terminal 29 is the cell 27 which represents a retention flip-flop (Yes in Step S11). In this case, as shown in FIG. 10A, the indeterminate propagation preventing portion 13 further correlates the instance name INS27 and cell name RFF27 of the cell 27 with a cell name RFF37 which is a name of a power-off state output determinate cell 37 (shown in FIG. 8B) representing that the second power source 31 is the power source supplying power to the output of the cell 27 (retention flip-flop), whereby describing the correlation in the retention flip-flop replacement list 73 (Step S14).

When the processes described above with respect to all of the output terminals 28 and 29 are completed (Yes in Step S15), the cells 23 and 27 which represent the retention flip-flops closest to the outputs (output terminals 28 and 29) of the first power source separation region 21 are searched as the first searched cells among the plurality of cells 23 to 27 of the first power source separation region 21, resulting in generation of the retention flip-flop replacement list 73 mentioned above. Moreover, the cell 24 between the first searched cell 23 and the output terminal 28 is searched as the second searched cell among the plurality of cells 23 to 27 of the first power source separation region 21, resulting in generation of the normally ON cell replacement list 74 mentioned above.

Referring to the retention flip-flop replacement list 73, the indeterminate propagation preventing portion 13 connects the second power source 31 to the first searched cells 23 and 27 to determine the outputs thereof, whereby generating the power-off state output determinate cells 33 and 37, respectively. In specific, the power source to be connected to the output circuit 53 of the first searched cells 23 and 27 is replaced from the first power source 30 to the second power source 31 as shown in. FIG. 8B. It may be deemed that the output circuit 53 is replaced by the output circuit 50. Thus, the first searched cells 23 and 27 are replaced by the power-off state output determinate cells 33 and 37, respectively (Step S16: retention flip-flop conversion process).

Also, in Step S16, referring to the retention flip-flop replacement list 73, the indeterminate propagation preventing portion 13 replaces the cell names RFF23 and RFF27 of the first searched cells 23 and 27 included in the net list 72 by the cell names RFF33 and RFF37 of the power-off state output determinate cells 33 and 37, respectively.

The indeterminate propagation preventing portion 13 connects the second power source 31 to the second searched cell 24 referring to the normally ON cell replacement list 74 thereby generating the normally ON cell 34. In specific, the power source to be connected to the second searched cell 24 is replaced from the first power source 30 to the second power source 31 as shown in FIG. 9B. It may be deemed that the P-channel transistors 60 and 62 of the first and second inverters 66 and 67 are replaced by P-channel transistors 64 and 65 of the first and second inverters 68 and 69, respectively. Thus, the second searched cell 24 is replaced by the normally ON cell 34 (Step S17: normally ON cell conversion process).

Also, in Step S17, referring to the normally ON cell replacement list 74, the indeterminate propagation preventing portion 13 replaces the cell name CEL24 of the second searched cell 24 included in the net list 72 by the cell name CON34 of the normally ON cell 34.

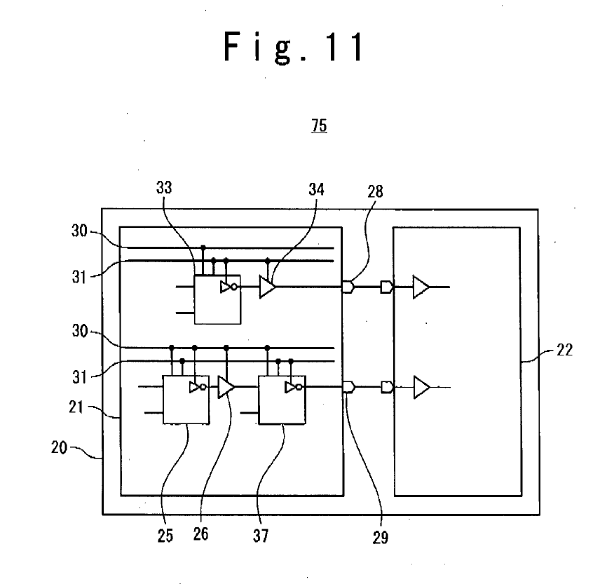

Thus, the indeterminate signal propagation preventing process (Step S4) is ended. At this time, the circuit diagram data 71 mentioned above is replaced by circuit diagram data 75 as shown in FIG. 11. That is, the cells 23, 24 and 27 are replaced by the cells 33, 34 and 37.

Thereafter, the layout data generation portion 14 generates the layout data 8 representing a layout formation based on the circuit diagram data 75 and the net list 72 and displays the layout data 8 on the display portion 3 (Step S5).

As described above, in the designing method of the semiconductor integrated circuit device according to the first embodiment of the present invention, the plurality of the power source separation regions 21, 22, . . . are individually provided with a plurality of cells including retention flip-flops. Therefore, in the case where the first power source 30 supplying power to the first power source separation region 21 is turned off when the outputs (output terminals 28 and 29) of the first power source separation region 21 is connected to the input of the second power source separation region 22, the search is executed. In this search, the first searched cells 23 and 27 representing the retention flip-flops closest to the outputs (output terminals 28 and 29) of the first power source separation region 21 are searched, and the second searched cell 24 between the first searched cell 23 and the output (output terminal 28) of the first power source separation region 21 is searched. Then, the power source supplying power to the outputs of the first search cells 23 and 27 is replaced from the first power source 30 to the second power source 31. Here, the second power source 31 supplies the same voltage as that of the first power source 30 and is in the ON state all the time. In addition, the power source supplying power to the second search cell 24 is replaced from the first power source 30 to the second power source 31. As described above, in the designing method of the semiconductor integrated circuit device according to the first embodiment of the present invention, the second power source 31 is connected to the outputs of the first searched cells 23 and 27 (retention flip-flops) inside the first power source separation region 21 thereby determining the outputs of the first search cells 23 and 27. Thus, it is possible to prevent an indeterminate signal from propagating from the region (first power source separation region 21) in the power-off state to the region (second power source separation region 22) in the power-on state. Moreover, since it is not necessary to provide an indeterminate propagation preventing circuit and a circuit for generating an enable signal between the regions, the chip area can be suppressed from increasing.

### Second Embodiment

As described above, in the first embodiment, if there exist a lot of cells between the output terminals 28 and 29 and the retention flip-flops when the retention flip-flops are searched from the outputs (output terminals) of the first power source separation region 21, the cells which are replaced by the normally ON power source (second power source 31) are increased at the time of replacement, and therefore there is a possibly to increase a leak current. The second embodiment takes into consideration a problem like this. In the second embodiment, the explanation thereof overlapped with that of the first embodiment is omitted here.

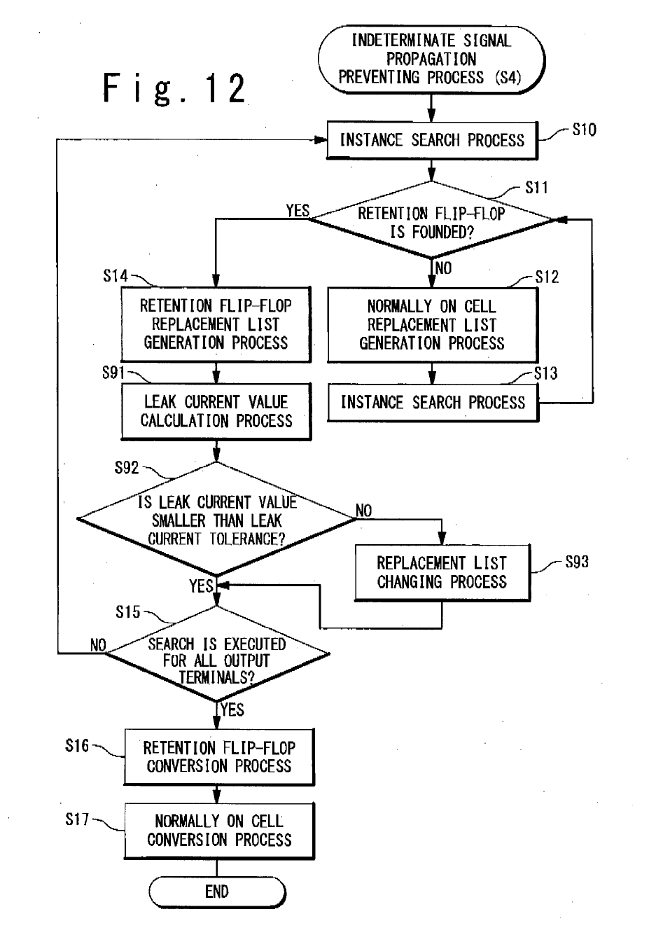

FIG. 12 is a flow chart showing an indeterminate signal propagation preventing process (Step S4) of a designing method of a semiconductor integrated circuit device according to the second embodiment of the present invention.

After execution of Step S14, the indeterminate propagation preventing portion 13 calculates a leak current value, which increases when the power source supplying power to outputs of the first searched cells 23 and 27 is replaced from the first power source 30 to the second power source 31, as a first leak current value by simulation. That is, the indeterminate propagation preventing portion 13 calculates a leak current value, which increases when the first searched cells 23 and 27 are replaced by the power-off state output determinate cells 33 and 37, respectively, as a first leak current value by simulation. Also, the indeterminate propagation preventing portion 13 calculates a leak current value, which increases when a power source supplying power to the second searched cell 24 is replaced from the first power source 30 to the second power source 31, as a second leak current value by simulation. That is, the indeterminate propagation preventing portion 13 calculates a leak current value, which increases when the second searched cell 24 is replaced by the normally ON cell 34, as a second leak current value by simulation (Step S91).

When the first and second leak current values are smaller than a leak current tolerance (Yes in Step S92), the processes of Step S15 and subsequent Steps are executed. The leak current tolerance is a preset value.

On the other hand, when at least one of the first and second leak current values is equal to or larger than the leak current tolerance (No in Step S92), the indeterminate propagation preventing portion 13 deletes the contents relating to the corresponding first searched cell among the contents relating to the first searched cells described in the retention flip-flop replacement list 73. Herein, it is presumed that the corresponding first searched cell is the first searched cell 23. Also, the indeterminate propagation preventing portion 13 deletes the contents relating to the corresponding second searched cell among the contents relating to the second searched cells described in the normally ON cell replacement list 74. Herein, if the corresponding first searched cell is the first searched cell 23, it is presumed that the corresponding second searched cell is the second searched cell 24 that is connected to the output of the first searched cell 23. Thus, Steps S16 and 317 for the corresponding first searched cell (first searched cell 23) and the corresponding second searched cell (second searched cell 24) are not executed. In this case, an indeterminate signal is propagated from the first power source separation region 21 to the second power source separation region 22. Therefore, in order to prevent the indeterminate signal from propagating from the first power source separation region 21 to the second power source separation region 22 when the first power source 30 supplying power to the first power source separation region 21 is in the OFF state, the indeterminate propagation preventing portion 13 provides the indeterminate propagation preventing circuit 200 between the outputs (output terminals 28 and 29) of the first power source separation region 21 and the input of the second power source separation region 22 as described above (Step S93). Thereafter, the processes of Step S15 and subsequent Steps are executed.

As, described above, in the designing method of the semiconductor integrated circuit device according to the second embodiment of the present invention, with calculation of a leak current value that increases when the first searched cells 23 and 27 are replaced by the power-off state output determinate cells 33 and 37, respectively, and a leak current value that increases when the power source supplying power to the second searched cell 24 is replaced from the first power source 30 to the second power source 31, only when the calculated leak current values are equal to or larger than the leak current tolerance, the indeterminate propagation preventing circuit is provided between the regions 21 and 22. By this arrangement, the leak current can be prevented from increasing.

According to the designing method of the semiconductor integrated circuit device of the present invention, each of the plurality of power source separation regions (21, 22, . . . ) is provided with a plurality of cells including a retention flip-flop. At this stage, when the outputs (28, 29) of the first power source separation region (21) are connected to an input of the second power source separation region (22), in the case where the first power source (30) supplying power to the first power source separation region (21) is turned off, the outputs of the retention flip-flops represented by the first searched cells (23, 27) in the first power source separation region (21) are determined. Thus, it becomes possible to prevent an indeterminate signal from propagating from a region in a power-off state (i.e., first power source separation region (21)) to a region in a power-on state (i.e., second power source separation region (22)). In addition, since there is no need to provide an indeterminate propagation preventing circuit and an enable signal generation circuit between the regions, it is possible to suppress the increase of the chip area.

It is apparent that the present invention is not limited to the above embodiment, but may be modified and changed without departing from the scope and spirit of the invention.

Although the present invention has been described above in connection with several exemplary embodiments thereof, it would be apparent to those skilled in the art that those exemplary embodiments are provided solely for illustrating the present invention, and should not be relied upon to construe the appended claims in a limiting sense.

What is claimed is:

1. A designing method of a semiconductor circuit device comprising:
generating a circuit diagram data indicating a semiconductor circuit device which includes a plurality of power source separation regions, each of said plurality of power source separation regions being provided with a plurality of cells which includes a plurality of retention flip-flops;
generating a net list indicating wiring lines between said plurality of power source separation regions and nodes connected thereof, based on said circuit diagram data;
when an output of a first power source separation region of said plurality of power source separation regions is connected to an input of a second power source separation region of said plurality of power source separation regions, and a first power source supplied to said first power source separation region is turned off, searching a first searched cell indicating a retention flip-flop closest to said output of said first power source separation region from said plurality of cells of said first power source separation region, based on said net list;
searching a second searched cell between said first searched cell and said output of said first power source separation region from said plurality of cells of said first power source separation region, based on said net list;
replacing a power source supplied to an output of said first searched cell from said first power source to a second power source which supplies the same voltage as that of said first power source and is in an on-state all the time; and
replacing a power source supplied to said second searched cell from said first power source to said second power source.

2. The designing method of a semiconductor circuit device according to claim 1, wherein said net list includes a first instance name of said first searched cell, a first cell name of said first searched cell, a second instance name of said second searched cell and a second cell name of said second searched cell,
wherein said designing method of a semiconductor circuit device, further comprising:
generating a retention flip-flop replacement list correlating said first instance name and said first cell name with a third cell name of a power-off state output determinate cell which indicates that a power source supplied to said output of said first searched cell is said second power source; and
generating a normally ON cell replacement list correlating said second instance name and said second cell name with a fourth cell name of a normally ON cell which indicates that a power source supplied to said second searched cell is said second power source,
wherein said step of replacing a power source supplied to said output of said first searched cell from said first power source to said second power source, includes:
generating said power-off state output determinate cell by connecting said output of said first searched cell to said second power source based on said retention flip-flop replacement list to determine an output signal from said output, and
wherein said step of replacing a power source supplied to said second searched cell from said first power source to said second power source, includes:
generating said normally ON cell by connecting said second searched cell to said second power source based on said normally ON cell replacement list.

3. The designing method of a semiconductor circuit device according to claim 2, wherein said step of replacing a power source supplied to said output of said first searched cell from said first power source to said second power source, further includes:
replacing said, first cell name included in said net list by said third cell name based on said retention flip-flop replacement list, and
wherein said step of replacing a power source supplied to said second searched cell from said first power source to said second power source, further includes:
replacing said second cell name included in said net list by said fourth cell name based on said normally ON cell replacement list.

4. The designing method of a semiconductor circuit device according to claim 1, wherein said retention flip-flop closest as said first searched cell includes:
an input circuit inputting data,
a holding circuit holding said data, and
an output circuit outputting said data based on a clock signal,
wherein said input circuit and said output circuit are connected to said first power source, and said holding circuit is connected to said second power source, and
wherein said step of replacing a power source supplied to said output of said first searched cell from said first power source to said second power source, includes:
connecting said output circuit to said second power source.

5. The designing method of a semiconductor circuit device according to claim 1, wherein said second searched cell includes a plurality of circuits,
wherein said plurality of circuits is connected to said first power source, and
wherein said step of replacing a power source supplied to said second searched cell from said first power source to said second power source, includes:
connecting said plurality of circuits to said second power source.

6. The designing method of a semiconductor circuit device according to claim 1, further comprising:
calculating a leak current value which increases when said step of replacing a power source supplied to said output of said first searched cell from said first power source to said second power source, as a first leak current value by simulation;
calculating a leak current value which increases when said step of replacing a power source supplied to said second searched cell from said first power source to said second power source, as a second leak current value by simulation; and
providing an indeterminate propagation preventing circuit between said output of said first power source separation region and said input of said second power source separation region when at least one of said first leak current value and said second leak current value is equal to or larger than a preset leak current tolerance, said indeterminate propagation preventing circuit preventing an indeterminate signal from propagating from said first power source separation region to said second power source separation region when said first power source supplied to said first power source separation region is in a power-off state.

7. A computer-readable medium including a computer program comprising code operable to control a computer for a designing method of a semiconductor circuit device, the code comprising;
generating a circuit diagram data indicating a semiconductor circuit device which includes a plurality of power source separation regions, each of said plurality of power source separation regions being provided with a plurality of cells which includes a plurality of retention flip-flops;
generating a net list indicating wiring lines between said plurality of power source separation regions and nodes connected thereof, based on said circuit diagram data;
when an output of a first power source separation region of said plurality of power source separation regions is connected to an input of a second power source separation region of said plurality of power source separation regions, and a first power source supplied to said first power source separation region is turned off, searching a first searched cell indicating a retention flip-flop closest to said output of said first power source separation region from said plurality of cells of said first power source separation region, based on said net list;
searching a second searched cell between said first searched cell and said output of said first power source separation region from said plurality of cells of said first power source separation region, based on said net list;
replacing a power source supplied to an output of said first searched cell from said first power source to a second power source which supplies the same voltage as that of said first power source and is in an on-state all the time; and
replacing a power source supplied to said second searched cell from said first power source to said second power source.

8. The computer-readable medium according to claim 7, wherein said net list includes a first instance name of said first searched cell, a first cell name of said first searched cell, a second instance name of said second searched cell and a second cell name of said second searched cell,
wherein said designing method of a semiconductor circuit device, further comprising:
generating a retention flip-flop replacement list correlating said first instance name and said first cell name with a third cell name of a power-off state output determinate cell which indicates that a power source supplied to said output of said first searched cell is said second power source; and
generating a normally ON cell replacement list correlating said second instance name and said second cell name with a fourth cell name of a normally ON cell which indicates that a power source supplied to said second searched cell is said second power source,
wherein said step of replacing a power source supplied to said output of said first searched cell from said first power source to said second power source, includes:
generating said power-off state output determinate cell by connecting said output of said first searched cell to said second power source based on said retention flip-flop replacement list determine an output signal from said output, and
wherein said step of replacing a power source supplied to said second searched cell from said first power source to said second power source, includes:
generating said normally ON cell by connecting said second searched cell to said second power source based on said normally ON cell replacement list.

9. The computer-readable medium according to claim 8, wherein said step of replacing a power source supplied to said output of said first searched cell from said first power source to said second power source, further includes:
replacing said first cell name included in said net list by said third cell name based on said retention flip-flop replacement list, and
wherein said step of replacing a power source supplied to said second searched cell from said first power source to said second power source, further includes:
replacing said second cell name included in said net list by said fourth cell name based on said normally ON cell replacement list.

10. The computer-readable medium according to claim 7, wherein said retention flip-flop closest as said first searched cell includes:
an input circuit inputting data a holding circuit holding said data, and
an output circuit outputting said data based on a clock signal,
wherein said input circuit and said output circuit are connected to said first power source, and said holding circuit is connected to said second power source, and
wherein said step of replacing a power source supplied to said output of said first searched cell from said first power source to said second power source, includes:
connecting said output circuit to said second power source.

11. The computer-readable medium according to claim 7, wherein said second searched cell includes a plurality of circuits,
wherein said plurality of circuits is connected to said first power source, and
wherein said step of replacing a power source supplied to said second searched cell from said first power source to said second power source, includes:
connecting said plurality of circuits to said second power source.

12. The computer-readable medium according to claim 7, further comprising:
calculating a leak current value which increases when said step of replacing a power source supplied to said output of said first searched cell from said first power source, to said second power source, as a first leak current value by simulation;
calculating a leak current value which increases when said step of replacing a power source supplied to said second searched cell from said first power source to said second power source, as a second leak current value by simulation; and
providing an indeterminate propagation preventing circuit between said output of said first power source separation region and said input of said second power source separation region when at least one of said first leak current value and said second leak current value is equal to or larger than a preset leak current tolerance, said indeterminate propagation preventing circuit preventing an indeterminate signal from propagating from said first power source separation region to said second power source separation region when said first power source supplied to said first power source separation region is in a power-off state.

13. A designing system of a semiconductor circuit device comprising:
a circuit diagram data generating portion configured to generate a circuit diagram data indicating a semiconductor circuit device which includes a plurality of power source separation regions, each of said plurality of power source separation regions being provided with a plurality of cells which includes a plurality of retention flip-flops;
a net list generating portion configured to generate a net list indicating wiring lines between said plurality of power source separation regions and nodes connected thereof, based on said circuit diagram data; and
an indeterminate propagation preventing portion,
wherein when an output of a first power source separation region of said plurality of power source separation regions is connected to an input of a second power source separation region of said plurality of power source separation regions, and a first power source supplied to said first power source separation region is turned off, said indeterminate propagation preventing portion:
searches a first searched cell indicating a retention flip-flop closest to said output of said first power source separation region from said plurality of cells of said first power source separation region, based on said net list,
searches a second searched cell between said first searched cell and said output of said first power source separation region from said plurality of cells of said first power source separation region, based on said net list;
replaces a power source supplied to an output of said first searched cell from said first power source to a second power source which supplies the same voltage as that of said first power source and is in an on-state all the time, and
replaces a power source supplied to said second searched cell from said first power source to said second power source.

14. The designing system of a semiconductor circuit device according to claim 13, wherein said net list includes a first instance name of said first searched cell, a first cell name of said first searched cell, a second instance name of said second searched cell and a second cell name of said second searched cell,
wherein said indeterminate propagation preventing portion;
generates a retention flip-flop replacement list correlating said first instance name and said first cell name with a third cell name of a power-off state output determinate cell which indicates that a power source supplied to said output of said first searched cell is said second power source; and
generates a normally ON cell replacement list correlating said second instance name and said second cell name with a fourth cell name of a normally ON cell which indicates that a power source supplied to said second searched cell is said second power source,
when replacing a power source supplied to said output of said first searched cell from said first power source to said second power source, generates said power-off state output determinate cell by connecting said output of said first searched cell to said second power source based on said retention flip-flop replacement list to determine an output signal from said output, and
when replacing a power source supplied to said second searched cell from said first power source to said second power source, generates said normally ON cell by connecting said second searched cell to said second power source based on said normally ON cell replacement list.

15. The designing system of a semiconductor circuit device according to claim 14, wherein said indeterminate propagation preventing portion:
when replacing a power source supplied to said output of said first searched cell from said first power source to said second power source, replaces said first cell name included in said net list by said third cell name based on said retention flip-flop replacement list, and
when replacing a power source supplied to said second searched cell from said first power source to said second power source, replaces said second cell name included in said net list by said fourth cell name based on said normally ON cell replacement list.

16. The designing system of a semiconductor circuit device according to claim 13, wherein said retention flip-flop closest as said first searched cell includes:
an input circuit inputting data,
a holding circuit holding said data, and
an output circuit outputting said data based on a clock signal,
wherein said input circuit and said output circuit are connected to said first power source, and said holding circuit is connected to said second power source, and
wherein said indeterminate propagation preventing portion, when replacing a power source supplied to said output of said first searched cell from said first power source to said second power source, connects said output circuit to said second power source.

17. The designing system of a semiconductor circuit device according to claim 13, wherein said second searched cell includes a plurality of circuits,
wherein said plurality of circuits is connected to said first power source, and
wherein said indeterminate propagation preventing portion, when replacing a power source supplied to said second searched cell from said first power source to said second power source, connects said plurality of circuits to said second power source.

18. The designing system of a semiconductor circuit device according to claim 13, wherein said indeterminate propagation preventing portion:
calculates a leak current value which increases when said step of replacing a power source supplied to said output of said first searched cell from said first power source to said second power source, as a first leak current value by simulation,
calculates a leak current value which increases when said step of replacing a power source supplied to said second searched cell from said first power source to said second power source, as a second leak current value by simulation, and
provides an indeterminate propagation preventing circuit between said output of said first power source separation region and said input of said second power source separation region when at least one of said first leak current value and said second leak current value is equal to or larger than a preset leak current tolerance, said indeterminate propagation preventing circuit preventing an indeterminate signal from propagating from said first power source separation region to said second power source separation region when said first power source supplied to said first power source separation region is in a power-off state.

19. A semiconductor circuit device designed by a designing method of a semiconductor circuit device, wherein said designing method comprising:
generating a circuit diagram data indicating a semiconductor circuit device which includes a plurality of power source separation regions, each of said plurality of power source separation regions being provided with a plurality of cells which includes a plurality of retention flip-flops;
generating a net list indicating wiring lines between, said plurality of power source separation regions and nodes connected thereof, based on said circuit diagram data;
when an output of a first power source separation region of said plurality of power source separation regions is connected to an input of a second power source separation region of said plurality of power source separation regions, and a first power source supplied to said first power source separation region is turned off, searching a first searched cell indicating a retention flip-flop closest to said output of said first power source separation region from said plurality of cells of said first power source separation region, based on said net list;
searching a second searched cell between said first searched cell and said output of said first power source separation region from said plurality of cells of said first power source separation region, based on said net list;
replacing a power source supplied to an output of said first searched cell from said first power source to a second power source which supplies the same voltage as that of said first power source and is in an on-state all the time; and
replacing a power source supplied to said second searched cell from said first power source to said second power source.

20. The semiconductor circuit device according to claim 19, wherein said net list includes a first instance name of said first searched cell, a first cell name, of said first searched cell, a second instance name of said second searched cell and a second cell name of said second searched cell,
wherein said designing method further comprising:
generating a retention flip-flop replacement list correlating said first instance name and said first cell name with a third cell name of a power-off state output determinate cell which indicates that a power source supplied to said output of said first searched cell is said second power source; and
generating a normally ON cell replacement list correlating said second instance name and said second cell name with a fourth cell name of a normally ON cell which indicates that a power source supplied to said second searched cell is said second power source,
wherein said step of replacing a power source supplied to said output of said first searched cell from said first power source to said second power source, includes:
generating said power-off state output determinate cell by connecting said output of said first searched cell to said second power source based on said retention flip-flop replacement list to determine an output signal from said output, and
wherein said step of replacing a power source supplied to said second searched cell from said first power source to said second power source, includes:
generating said normally ON cell by connecting said second searched cell to said second power source based on said normally ON cell replacement list.
